(19) United States
(12) Patent Application Publication
(10) Pub. No.: US 2015/0370290 A1
(43) Pub. Date: Dec. 24, 2015

(54) ELECTRONIC APPARATUS, METHOD, AND STORAGE MEDIUM

(71) Applicant: KABUSHIKI KAISHA TOSHIBA, Tokyo (JP)

(72) Inventors: Jun WATANABE, Tokyo (JP); Hiroki KODAIRA, Tokyo (JP)

(73) Assignee: KABUSHIKI KAISHA TOSHIBA, Tokyo (JP)

(21) Appl. No.: 14/736,729

(22) Filed: Jun. 11, 2015

(30) Foreign Application Priority Data
Jun. 24, 2014 (JP) 2014-129195

(51) Int. Cl. G06F 1/16; G06F 3/0346

(52) U.S. Cl. CPC G06F 1/1694; G06F 1/1626; G06F 3/0346

(57) ABSTRACT

According to one embodiment, a portable electronic apparatus including a contactless communication module configured to execute contactless communication with an external device is provided. The electronic apparatus includes a first detector, a second detector, and a controller. The first detector is configured to detect contactless communication with the external device. The second detector is configured to detect an orientation of the electronic apparatus. The controller is configured to execute control according to the detected orientation when the contactless communication with the external device is detected.

### CROSS-REFERENCE TO RELATED APPLICATIONS

this application is based upon and claims the benefit of priority from Japanese Patent Application No. 2014-129195, filed Jun. 24, 2014, the entire consents of which are incorporated herein by reference.

### FIELD

Embodiments described herein relate generally to an electronic apparatus, a method, and a storage medium.

In general, tablet computers, smartphones, PDAs and the like are known as portable electronic apparatuses.

There are some cases where these electronic apparatuses include a module (hereinafter referred to as a contactless communication module) configured to perform contactless communication such as near-field communication (NFC).

With the contactless communication module, it is possible to perform contactless communication between the electronic apparatus and an external device similarly including a contactless communication module (for example, contactless communication card or the like) simply by bringing (holding) the external decree close to (over) the electronic apparatus.

Recently, a technique of controlling an electronic apparatus to perform a specific operation when contactless communication is performed has been developed.

However, since the electronic apparatus in the above-described contactless communication performs only one kind of operation, the operation of the electronic apparatus lacks in variety (or extensibility.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a perspective diagram showing an example of an appearance of an electronic apparatus of the first embodiment.

FIG. 2 is a diagram for explaining an example of a contactless communication module provided on the back side of the electronic apparatus.

FIG. 3 is a diagram showing an example of a system configuration of the electronic apparatus of FIG. 1.

FIG. 4 is a block diagram showing an example of a function structure or the electronic apparatus of the present embodiment.

FIG. 5 is a flowchart showing an example of a processing procedure in the electronic apparatus of the present embodiment.

FIG. 6 is a diagram showing an example of an appearance of the electronic apparatus in the portrait orientation.

FIG. 7 is a diagram showing an example of an appearance of the electronic apparatus in the landscape orientation.

FIG. 8 is a diagram showing an example of a system configuration of an electronic apparatus of a second embodiment.

FIG. 9 is a flowchart showing an example of a processing procedure in the electronic apparatus of the present embodiment.

FIG. 10 is a flowchart showing an example of a processing procedure in an electronic apparatus of a third embodiment.

FIG. 11 is a flowchart showing an example of a processing procedure in an electronic apparatus of a fourth embodiment.

### DETAILED DESCRIPTION

Various embodiments will be described hereinafter with reference to the accompanying drawings.

In general, according to one embodiment, a portable electronic apparatus including a contactless communication module configured to execute contactless communication with an external device is provided. The electronic apparatus includes a first detector, a second detector, and a controller. The first detector is configured to detect contactless communication with the external device. The second detector is configured to detect an orientation of the electronic apparatus. The controller is configured to execute control according to the detected orientation when the contactless communication with the external device is detected.

### First Embodiment

First of all, the first embodiment will be described. FIG. 1 is a perspective diagram showing an example of the appearance of an electronic apparatus of the present embodiment. The electronic apparatus is a portable electronic apparatus and may be realized as, for example, a tablet computer, a smartphone, a PDA or the like. The following descriptions are based on the assumption that the electronic apparatus is realized as a tablet computer.

As shown in FIG. 1, a body 11 of an electronic apparatus 10 includes a thin box-shaped housing. On the upper surface of the body 11, a touchscreen display 12 is attached in such a manner as to be overlaid thereon.

In the touchscreen display 12, a flat panel display and a sensor which is configured to detect, for example, a contact position of the user's finger or the like on the screen of the flat panel display are incorporated. The flat panel display includes, for example, a liquid crystal display (LCD). As the sensor, for example, a capacitive touchpanel or the like may be used.

Note that, as shown in FIG. 1, the electronic apparatus 10 (as well as the touchscreen display 12) has a substantially rectangular shape when viewed from the front.

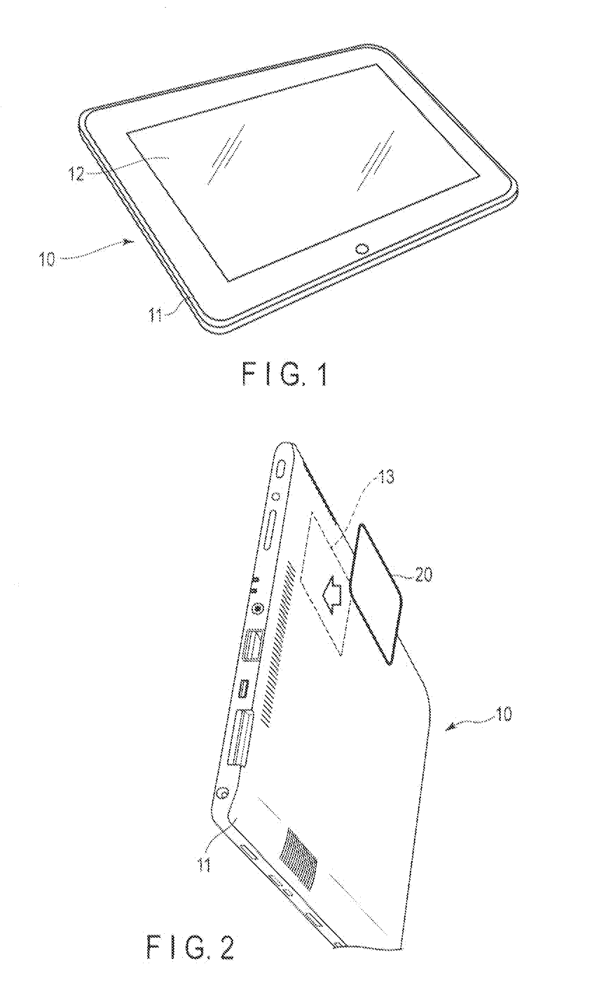

Further, as shown in FIG. 2, in a predetermined position on the back side of the electronic apparatus 10, a module (including an antenna, hereinafter referred to as a contactless communication module) 13 configured to execute contactless communication is provided. The contactless communication module 13 is used for executing contactless communication with contactless communication device (external device) 20 brought close to the contactless communication module 13. The contactless communication includes, for example, an NFC.

Further, the above-described contactless communication device 20 includes such contactless communication card or the like as that of FIG. 2. The contactless communication device 20 includes a contactless communication module in a manner similar to that of the electronic apparatus 10. Note that a device other than the contactless communication card may also be used as the contactless communication device 20 as long as the device is configured to perform contactless communication.

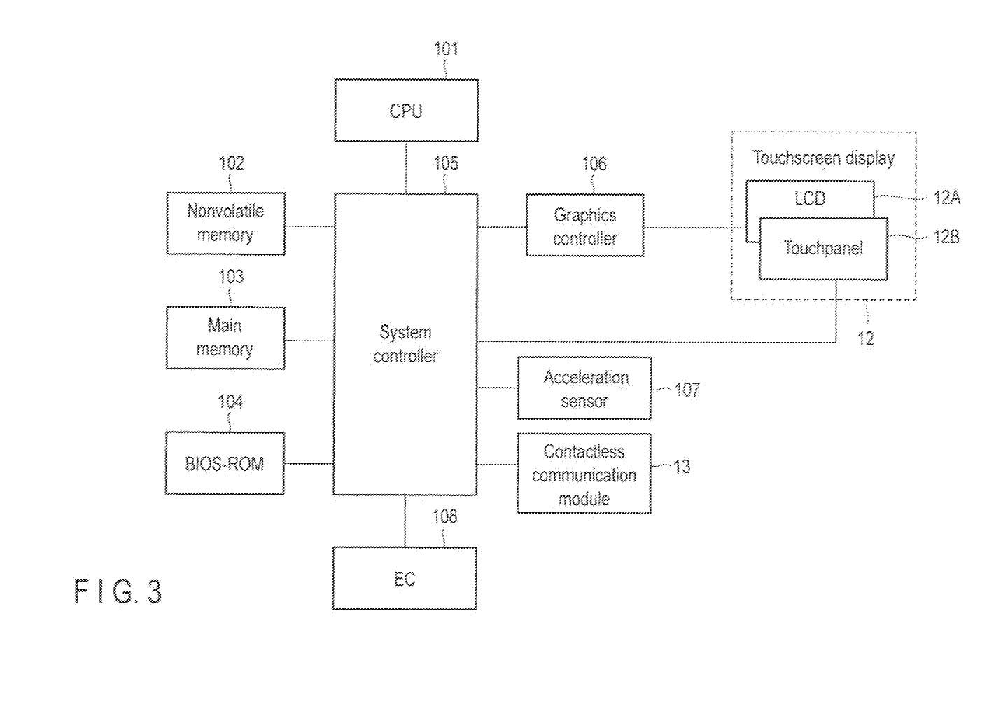

FIG. 3 is a diagram showing a system configuration of the electronic apparatus (tablet computer) 10 of the present embodiment. As shown in FIG. 3, the electronic apparatus 10 includes, for example, a CPU 101, a nonvolatile memory 102, a main memory 103, a BIOS-ROM 104, a system controller 105, a graphics controller 106, an acceleration sensor 107, an EC 108 and the like, in addition to the contactless communication module 13 shown in FIG. 1. Further, the touchscreen display 12 of FIG. 1 includes an LCD 12A and a touchpanel 12B.

The CPU 101 is a processor configured to control the operation of each component in the computer 10. The processor includes at least one processing circuitry. The CPU 101 executes various kinds of software loaded from a storage device, namely, the nonvolatile memory 102 to the main memory 103. The software includes an operating system (OS) and various application programs.

The CPU 101 also executes a basic input/output system (BIOS) stored in the BIOS-ROM 104. The BIOS is a program for hardware control.

The system controller 105 is a device configured to connect the local bus of the CPU 101 and various components. The system controller 105 includes a built-in memory controller configured to perform access control of the main memory 103. The system controller 105 also includes a function of performing a communication with the graphics controller 106 via a serial bus conforming to the PCI Express standard or the like.

The graphics controller 106 is a display controller configured to control the LCD 12A used as a display monitor of the electronic apparatus 10. The graphics controller 106 generates a display signal and transmits it to the LCD 12A. The LCD 12A displays a screen image based on the display signal. The touchpanel 12B is, for example, a capacitive pointing device configured to perform input on the screen of the LCD 12A. For example, a contact position touched with the user's finger on the screen, the movement of the contact position and the like are detected by the touchpanel 12B. With the touchpanel 12B, it is possible to operate a graphical user interface or the like displayed on the screen of the LCD 12A.

The acceleration sensor is a sensor configured to measure acceleration acting on the electronic apparatus 10. An acceleration (for example, acceleration due to gravity) measured by the acceleration sensor 107 can be used for detecting the orientation of the electronic apparatus 10 as will be described later.

The EC 108 is a single-chip microcomputer including an embedded controller for power management. The EC 108 includes a function of powering the electronic apparatus 10 on and off based on the user's operation of the power button.

Note that the contactless communication module 13 is a module configured to execute contactless communication with the contactless communication device 20 brought close to the contactless communication module 13 as described above, and is connected to, for example, the system controller 105 as shown in FIG. 3.

Further, although omitted in FIG. 3, the electronic apparatus 10 further includes, for example, a wireless LAN module configured to execute a wireless communication using a wireless LAN or the like, a Bluetooth (registered trademark) module configured to execute a wireless communication using Bluetooth with a Bluetooth-compatible device, and the like.

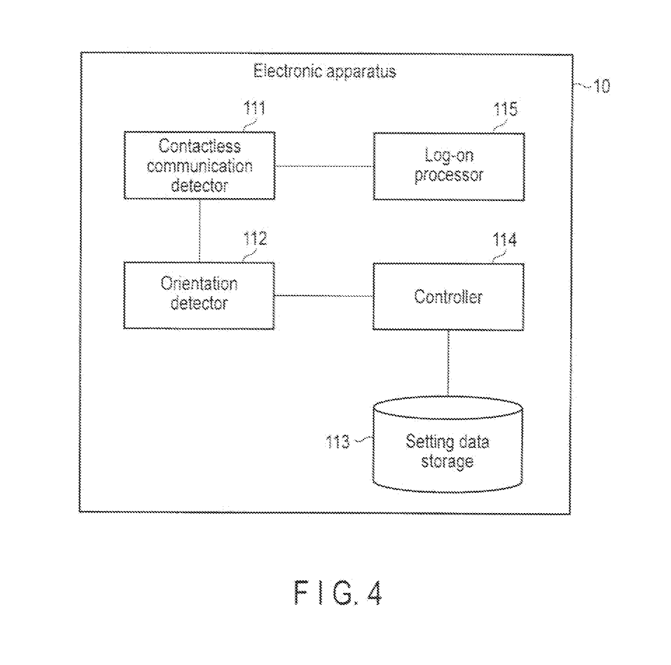

FIG. 4 is a block diagram mainly showing a function structure of the electronic apparatus 10 of the present embodiment. As shown in FIG. 4, the electronic apparatus 10 includes contactless communication detector 111, an orientation detector 112, a setting data storage 113, a controller 114 and a log-on processor 115. In the present embodiment, the contactless communication detector 111, the orientation detector 112, the controller 114 and the log-on processor 115 are assumed to be realized when, for example, dedicated software (application program) is executed by the CPU 101 (the computer of the electronic apparatus 10).

The contactless communication detector 111 is configured to detect the contactless communication between the above-described contactless communication module 13 and the external contactless communication device 20.

The orientation detector 112 is configured to obtain the acceleration (acceleration due to gravity) measured by the above-described acceleration sensor 107. The orientation detector 112 is configured to detect the orientation of the electronic apparatus 10 based on the obtained acceleration due to gravity. Note that the orientation detector 112 detects, for example, the portrait orientation or the landscape orientation as the orientation of the electronic apparatus 10.

The setting data storage 113 is configured to store (set) setting data in advance, the setting data indicating control on the electronic apparatus 10 according to the orientation of the electronic apparatus 10 detected by the orientation detector 112. More specifically, the setting data storage 113 stores setting data indicating control to be performed on the electronic apparatus 10 in a case where the electronic apparatus 10 is in the portrait orientation and setting data indicating control to be performed on the electronic apparatus 10 in a case where the electronic apparatus 10 is in the landscape orientation.

The controller 114 is configured, when contactless communication with the contactless communication device 20 is detected by the contactless communication detector 111, to perform control according to the orientation of the electronic apparatus 10 on the electronic apparatus 10 based on the orientation of the electronic apparatus 10 detected by the orientation detector 112 and the setting data stored in the setting data storage 113. That is, the controller 114 controls the electronic apparatus 10 to perform a predetermined operation according to the orientation of the electronic apparatus 10 detected by the orientation of the detector 112.

The log-on processor 115 is configured to execute log-on processing in the electronic apparatus 10 (that is, processing to log-on to the electronic apparatus 10) when contactless communication with the contactless communication device 20 is detected by the contactless communication detector 111 and if the electronic apparatus 10 has not been logged on to.

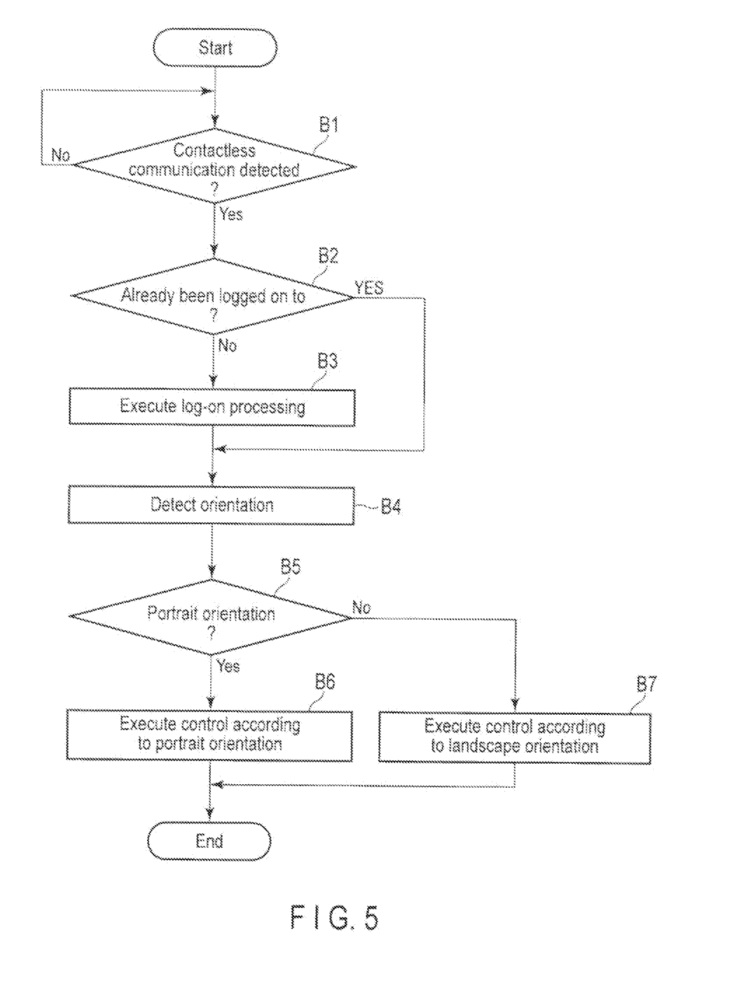

Next, with reference to the flowchart of FIG. 5, the processing procedure in the electronic apparatus 10 of the present embodiment will be described. Described below is processing executed in the electronic apparatus 10 when contactless communication is performed with an external device, namely, the contactless communication device 20.

Here, an example of the way of using the electronic apparatus 10 of the present embodiment will be briefly described. As an example of the way of using the electronic apparatus 10, for example, the electronic apparatus 10 can be used in a state of being held by a holder fixed to the wall of a room or the like (that is, in a state of being leaned on the wall). The holder is assumed, for example, to be configured to hold the electronic apparatus 10 in the portrait orientation or the landscape orientation.

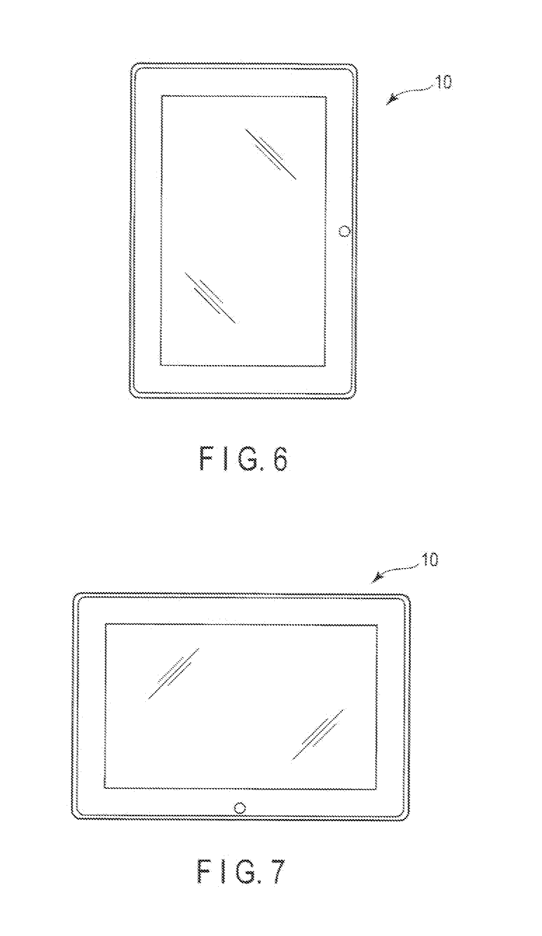

Note that the portrait orientation is assumed, as shown in FIG. 6, to indicate a state in which the long sides of the electronic apparatus 10 lie side by side and the short sides are on the top and at the bottom when the electronic apparatus 10 held by the holder is viewed from the front, for example. Conversely, the landscape orientation is assumed, as shown in FIG. 7, to indicate a state in which the long sides of the electronic apparatus 10 are on the top and at the bottom and the short sides lie side by side when the electronic apparatus 10 held by the holder is viewed from the front, for example.

Further, in a position close to the contactless communication module 13 provided on the back side of the electronic apparatus 10 when the electronic apparatus 10 is held by the holder in the portrait orientation or the landscape orientation, the contactless communication device (for example, contactless communication card) 20 is provided.

In this way, when the electronic apparatus 10 is held by the holder, the contactless communication device (for example, contactless communication card) 20 is in proximity to the contactless communication module 13 provided, for example, on the back side of the electronic apparatus 10, and thus the contactless communication module 13 can execute communication with the contactless communication device 20. When contactless communication is executed between the contactless communication module 13 and the contactless communication device 20 in this way, the contactless communication detector 111 detects the contactless communication.

Here, although it has been assumed that the electronic apparatus 10 is used in a state of being held by a holder fixed to the wall of a room, it is also possible to use the electronic apparatus 10, for example, in a state of being held in the user's hands in proximity to the contactless communication device 20.

Note that the contactless communication device 20 is assumed to store log-on information for executing log-on processing which will be described later. The log-on information is information for enabling (that is, logging on to) the electronic apparatus 10 and includes, for example, a user ID assigned to the user of the electronic apparatus 10, a password set by the user, and the like.

First, in the electronic apparatus 10, it is determined whether the above-described contactless communication with the contactless communication device 20 is detected by the contactless communication detector 111 or not (block B1).

When it is determined that no contactless communication with the contactless communication device 20 is detected (No in block B1), the processing of block B1 is repeated until the contactless communication is detected.

Conversely, when it is determined that the contactless communication with the contactless communication device 20 is detected (Yes in block B1), the log-on processor 115 determines whether the electronic apparatus 10 has already been logged on to or not (block B2).

When it is determined that the electronic apparatus 10 has not been logged on to (No in block B2), the log-on processor 115 receives the above-described log-on information stored in the contactless communication device 20 from the contactless communication device 20 by the contactless communication. The log-on processor 115 executes log-on processing based on the received log-on information (block B3). According to this log-on processing, user authentication is performed on the basis of a user ID and a password in the log-on information, and in a case where the user authentication succeeds (that is, the user ID and the password coincide with those registered in the electronic apparatus 10 in advance), the user is allowed to log on to the electronic apparatus 10.

Note that the processing of block B3 will not be executed when it is determined that the electronic apparatus 10 has already been logged on to (Yes in block B2).

Next, the orientation detector 112 obtains the acceleration due to gravity measured by the above-described acceleration sensor 107 and detects the orientation of the electronic apparatus 10 based on the acceleration due to gravity (block B4). In this case, the orientation detector 112 detects the portrait orientation as the orientation of the electronic apparatus 10, for example, in a case where the short sides of the electronic apparatus 10 are located in the direction in which the acceleration due to gravity acts (that is, the short sides of the electronic apparatus 10 are on the top and at the bottom). Conversely, the orientation detector 112 detects the landscape orientation as the orientation of the electronic apparatus 10, for example, in a case where the long sides of the electronic apparatus 10 are located in the direction in which the acceleration due to gravity acts (that is, the long sides of the electronic apparatus 10 are on the top and at the bottom).

Here, it is determined whether the orientation of the electronic apparatus 10 detected by the orientation detector 112 is the portrait orientation or not (block B5).

When the orientation of the electronic apparatus 10 is determined to be the portrait orientation (Yes in block B5), the controller 114 executes control (first control) according to the portrait orientation based on the setting data stored in the setting data storage 113 (block B6).

Conversely, when the orientation of the electronic apparatus 10 is determined not to be the portrait orientation (that is, to be the landscape orientation) (No in block B5), the controller 114 executes (second control) control according to the landscape orientation based on the setting data stored in the setting data storage 113 (block B7).

Now, the above-described processing of blocks B6 and B7 will be described more specifically. Here, the setting data storage 113 is assumed to store in advance setting data indicating, for example, activation of an application program (such as a document creation application program) used when the electronic apparatus 10 is in the portrait orientation as the control on the electronic apparatus 10 in the portrait orientation, and setting data indicating, for example, activation of an application program (such as a video viewing application program) used when the electronic apparatus 10 is in the landscape orientation as the control on the electronic apparatus 10 in the landscape orientation.

In this case, the controller 114 executes control to activate, for example, the document creation application program in block B6. Conversely, the controller 114 executes control to activate, for example, the video viewing application program in block B7.

In this way, for example, when the electronic apparatus 10 is held by the above-described holder in the portrait orientation, the user can use the document creation application program activated automatically as an application program according to the portrait orientation. Similarly, for example, when the electronic apparatus 10 is held by the holder in the landscape orientation, the user can use the video viewing application program activated automatically as an application program according to the landscape orientation.

Note that, although it has been assumed that a predetermined application program according to the orientation of the electronic apparatus 10 is activated, it is also possible to execute other control to operate the electronic apparatus 10 in a different operation mode based on the orientation. Further, it is also possible to appropriately change the contents (setting data) of the control according to the orientation of the electronic apparatus 10 based on the user's purpose of using the electronic apparatus 10 or the like.

Further, although it has been assumed that the orientation of the electronic apparatus 10 is detected in block B4 in FIG. 5, the orientation of the electronic apparatus 10 may be detected and stored in advance in the electronic apparatus 10. The same also applies to the following embodiments.

As described above, in the present embodiment, the orientation of the electronic apparatus 10 detected to be in contactless communication with the contactless communication device (external device) 20 is detected, for example, based on the acceleration (acceleration due to gravity) measured by the acceleration sensor 107, and depending on the detected orientation, different control is executed in the electronic apparatus 10. With this configuration, it becomes possible in the present embodiment to control the electronic apparatus 10 to perform various operations simply by changing the orientation of the electronic apparatus 10 when contactless communication is to be executed. In other words, it becomes possible in the present embodiment to increase operation variation of the electronic apparatus 10 in contactless communication with the contactless communication device 20 by adding an orientation of the electronic apparatus 10 in the contactless communication as a condition.

Further, in the present embodiment, in a case where contactless communication with the contactless communication device 20 is detected, processing to log-on to the electronic apparatus 10 is executed by using the log-on information stored in the contactless communication device 20. With this configuration, it is possible to automatically log on to the electronic apparatus 10 when the electronic apparatus 10 is brought close to the contactless communication device 20.

### Second Embodiment

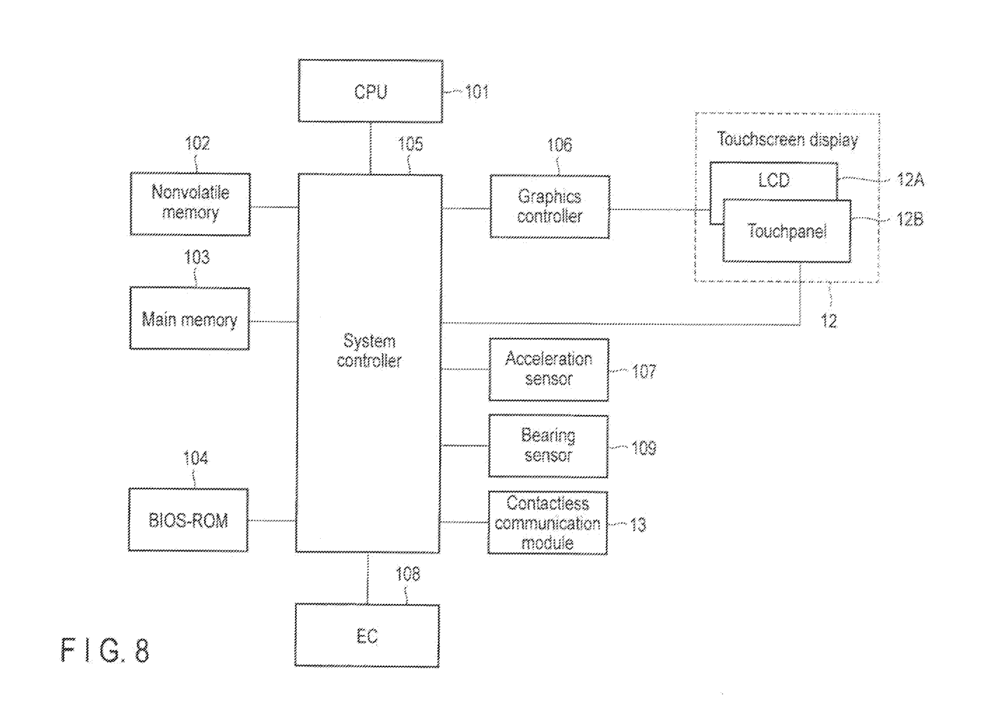

Next, the second embodiment will be described. FIG. 8 is a system configuration of the electronic apparatus of the present embodiment. Note that, in FIG. 8, components similar to those of FIG. 3 described above are denoted by the same reference numbers and detailed descriptions thereof will be omitted. Here, components different from those of FIG. 3 will be mainly described. Further, the appearance of the electronic apparatus of the present embodiment is similar to that of the first embodiment described above, and thus detailed description thereof will be omitted.

An electronic apparatus 10 of the present embodiment further includes a bearing sensor (compass sensor) 109 in addition to the above-described system configuration of the first embodiment. The bearing sensor 109 is a sensor configured to measure a bearing (azimuth) from (a position of) the electronic apparatus 10.

Note that the function structure of the electronic apparatus 10 of the present embodiment is similar to that of the first embodiment described above and will be appropriately described with reference to FIG. 4, and that the present embodiment is different from the above-described first embodiment in detecting the bearing in which the electronic apparatus 10 faces as the orientation of the electronic apparatus 10.

Further, in the present embodiment, the setting data storage 113 is assumed to store setting data indicating control on the electronic apparatus 10 according to each bearing in which the electronic apparatus 10 faces (that, is, each orientation of the electronic apparatus 10). Note that the contents of the control according to respective bearings (orientations) indicated by the setting data in the setting data storage 113 are different from each other.

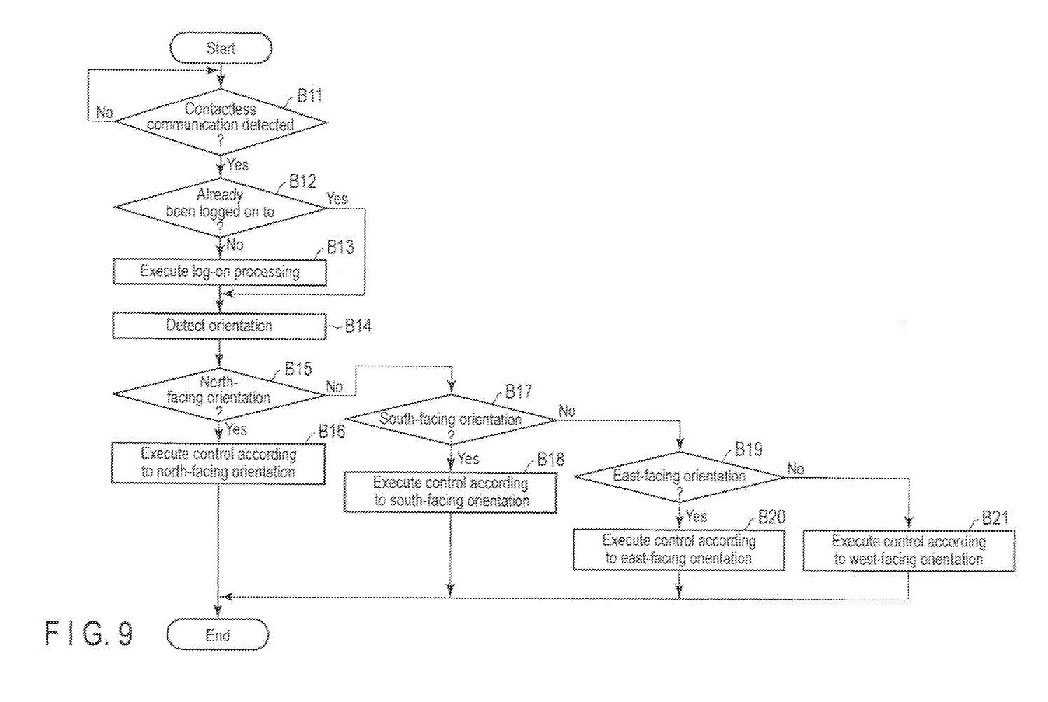

Now, with reference to the flowchart of FIG. 9, the processing procedure in the electronic apparatus 10 of the present embodiment will be described. Here, as in the case of the above-described first embodiment, the processing executed in the electronic apparatus 10 when contactless communication is performed with an external device, namely, the contactless communication device 20 will be described.

Note that, in the present embodiment, the electronic apparatus 10 is assumed to be used, for example, in a state of being held in the user's hands.

First, processing of blocks B11 to B13 corresponding to the above-described processing of blocks B1 to B3 of FIG. 5 is executed.

Next, the orientation detector 112 obtains a bearing (north, south, east, west, or the like) measured by the above-described bearing sensor 109, and detects the orientation of the electronic apparatus 10 (that is, the bearing in which the electronic apparatus 10 faces) based on the obtained bearing (block B14). Note that the orientation detector 112 is assumed to detect, for example, a north-facing orientation, a south-facing orientation, an east-facing orientation or a west-facing orientation as the orientation of the electronic apparatus 10.

Here, the processing of block B14 will be described more specifically. First, in the electronic apparatus 10, it is possible to detect the inclination of the electronic apparatus 10 based on the acceleration (acceleration due to gravity) measured by the acceleration sensor 107. When the user is assumed to be viewing the screen of the electronic apparatus 10 in a state of holding the electronic apparatus 10 in the hands and facing the screen, it is possible to estimate from the inclination of the electronic apparatus 10 that the user is it a position opposite to the screen of the electronic apparatus 10. In this case, the travelling direction of the user estimated in this way is assumed to be the direction in which the electronic apparatus 10 faces. Note that the travelling direction of the user is, for example, a direction opposite to (the direction of the horizontal component of) a direction perpendicular to the screen of the electronic apparatus 10. In this way, the orientation detector 112 can detect the bearing corresponding to the direction in which the electronic apparatus 10 faces (the travelling direction of the user) as the orientation of the electronic apparatus 10 (that is, the direction in which the electronic apparatus 10 faces).

Note that it has been assumed that the direction opposite to (the direction of the horizontal component of) a direction perpendicular to the screen of the electronic apparatus 10 is the direction in which the electronic apparatus 10 faces, but in contrast to this, it is also possible to assume that (the direction of the horizontal component of) a direction perpendicular to the screen of the electronic apparatus 10 is the direction in which the electronic apparatus 10 faces (that is, the direction in which the screen faces).

Note that the bearing corresponding to the direction in which the electronic apparatus 10 faces (that is, the orientation of the electronic apparatus 10) may be detected, for example, based on rules set in advance. The rules includes a rule in which, for example, in a case where the electronic apparatus 10 faces in the direction between the north and the east, the orientation of the electronic apparatus 10 may be detected as the north-facing orientation when the direction is more northerly than north easterly, and the orientation of the electronic apparatus 10 may be detected as the east-facing orientation when the direction is more easterly than north easterly. The same also applies to a case where other directions are detected as the orientations of the electronic apparatus 10.

Further, the bearing of a predetermined side (of the screen) of the electronic apparatus 10 (that is, the bearing in which the predetermined side is located with respect to the other sides) may be assumed as the bearing in which the electronic apparatus 10 faces.

When the bearing in which the electronic apparatus 10 faces is detected by the orientation detector 112 as described above, the controller 114 executes control according to the bearing (that is, the orientation of the electronic apparatus 10) based on the setting data stored in the above-described setting data storage 113.

In that case, first, the controller 114 determines whether the orientation of the electronic apparatus 10 is the north-facing orientation (that is, the bearing in which the electronic apparatus faces is the north) or not (block B15). When the orientation of the electronic apparatus 10 is determined to be the north-facing orientation (Yes in block B15), the controller 114 executes control according to the north-facing orientation (block B16).

Conversely, when the orientation of the electronic apparatus 10 is determined not to be the north-facing orientation (No in block B15), the controller 114 determines whether the orientation of the electronic apparatus 10 is the south-facing orientation (that is, the bearing in which the electronic apparatus 10 faces is the south) or not (block B17). When the orientation of the electronic apparatus 10 is determined to be the south-facing orientation (Yes in block B17), the controller 114 executes control according to the south-facing orientation (block B18).

Conversely, when the orientation of the electronic apparatus 10 is determined not to be the south-facing orientation (No in block B17), the controller 114 determines whether the orientation of the electronic apparatus 10 is the east-facing orientation (that is, the bearing in which the electronic apparatus 10 faces is the east) or not (block B19). When the orientation of the electronic apparatus 10 is determined to be the east-facing orientation (Yes in block B19), the controller 114 executes control according to the east-facing orientation (block B20).

Conversely, when the orientation of the electronic apparatus 10 is determined not to be the east-facing orientation (that is, to be the west-facing orientation) (No in block B19), the controller 114 executes control according to the west-facing orientation (block B21).

As described above, in the present embodiment, the bearing in which the electronic apparatus 10 faces is detected as the orientation of the electronic apparatus 10, and control according to the detected bearing is executed in the electronic apparatus 10. With this configuration, it is possible in the present embodiment to execute, for example, four kinds of control based on the bearing in which the electronic apparatus 10 faces (north, south, east or west, or the like), and thus it becomes possible to control the electronic apparatus 10 to perform more various operations as compared to the case of the above-described first embodiment where the control according to the portrait orientation and the control according to the landscape orientation is executed.

Note that, in the present embodiment, although it has been assumed that different control is executed depending on the bearing in which the electronic apparatus 10 faces, it is also possible, for example, to execute control in consideration with the direction such as control on the electronic apparatus 10 to output information of a store located in the bearing (direction) in which the electronic apparatus 10 is facing or execute control not related to the direction.

### Third Embodiment

Next, the third embodiment will be described. Note that the appearance of the electronic apparatus of the present embodiment, the system configuration and the function structure are similar to those of the above-described first embodiment and thus will be appropriately described with reference to FIGS. 1 to 4.

The present embodiment is different from the above-described first embodiment in powering the electronic apparatus off when a face-down orientation is detected as the orientation of the electronic apparatus 10. That is, the setting data storage 113 in the present embodiment stores setting data indicating power-off of the electronic apparatus 10 as the contents of the control on the electronic apparatus 10 in the face-down orientation.

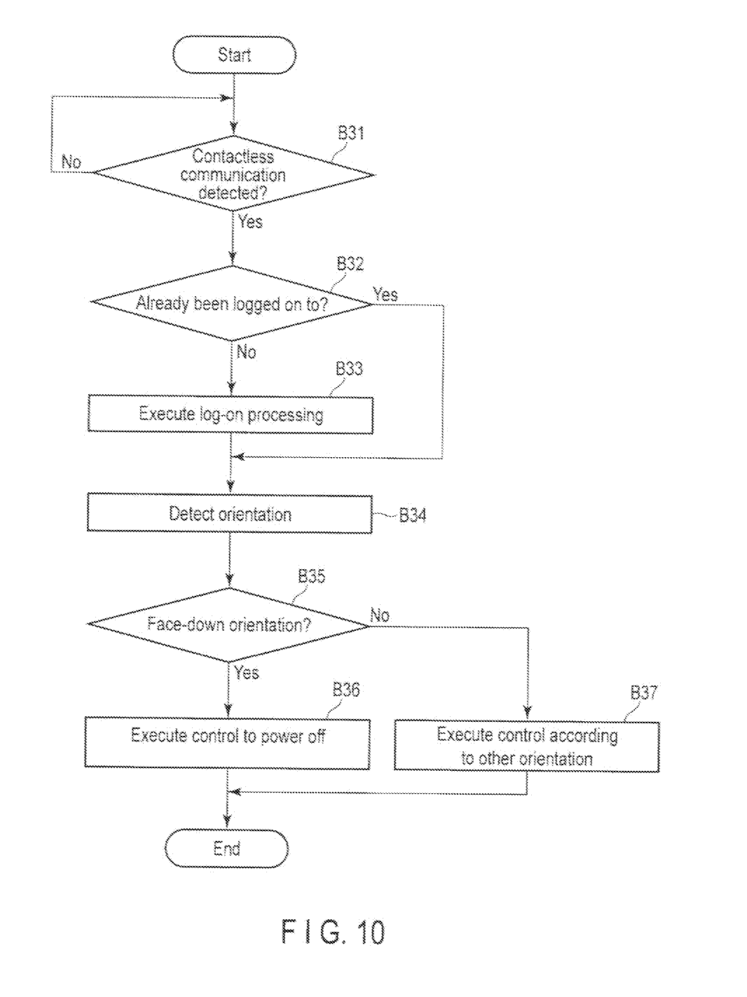

Now, with reference to the flowchart of FIG. 10, the processing procedure in the electronic apparatus 10 of the present embodiment will be described. Here, as in the case of the above-described first embodiment, the processing executed in the electronic apparatus 10 when contactless communication is performed with an external device, namely, the contactless communication device 20 will be described.

First, processing of blocks B31 to B33 corresponding to the above-described processing of blocks B1 to B3 of FIG. 5 is executed.

Next, the orientation detector 112 obtains the acceleration due to gravity measured by the acceleration sensor 107, and detects the orientation of the electronic apparatus 10 based on the acceleration due to gravity (block B34). In this case, the orientation detector 112 is configured to further detect the face-down orientation in addition to the portrait and landscape orientations described in the first embodiment. Here specifically, it is possible to detect the inclination of the electronic apparatus 10 based on the acceleration due to gravity measured by the acceleration sensor 107 as described above, and in a case where it is determined on the basis of the inclination of the electronic apparatus 10 that the screen of the electronic apparatus 10 faces down (for example, the electronic apparatus 10 is placed on a table or the like in a state of being upside down), the orientation detector 112 detects the face-down orientation as the orientation of the electronic apparatus 10.

Here, it is determined whether the orientation of the electronic apparatus 10 detected by the orientation detector 112 is the face-down orientation or not (block B35).

When the orientation of the electronic apparatus 10 is determined to be the face-down orientation (Yes in block B35), the controller 114 executes control according to the face-down orientation based on the setting data stored in the setting data storage 113. In a case where the setting data storage 113 stores, as described above, setting data indicting power-off of the electronic apparatus 10 as the contents of the control on the electronic apparatus 10 in the face-down orientation, the controller 114 executes control to power the electronic apparatus 10 off by shutting down the electronic apparatus 10 forcefully (block B36).

Conversely, when the orientation of the electronic apparatus 10 is determined not to be the face-down orientation (that is, to be the portrait orientation or the landscape orientation), the controller 114 executes control according to the orientation other than the face-down orientation detected by the orientation detector 112 based on the setting data stored in the setting data storage 111 (block B37). More specifically, the above-described processing of block B6 of FIG. 5 is executed when the orientation of the electronic apparatus 10 is the portrait orientation, and the above-described processing of block B7 of FIG. 5 is executed when the orientation of the electronic apparatus 10 is the landscape orientation.

As described above, in the present embodiment, control to power the electronic apparatus 10 off is executed in the case of detecting the face-down orientation as the orientation of the electronic apparatus 10 based on the acceleration (acceleration due to gravity) measured by the acceleration sensor 107. In the present embodiment, since the electronic apparatus 10 will not generally be operated when the electronic apparatus 10 is in the face-down orientation (that is, the electronic apparatus 10 faces down) on the table or the like even if, for example, contactless communication is performed by mistake when the contactless communication device 20 is brought close to the electronic apparatus 10 (contactless module 13), the electronic apparatus 10 is powered off to avoid unnecessary power consumption.

Conversely, as in the above-described first embodiment, for example, it is possible to execute the control according to the portrait orientation when the electronic apparatus 10 is held by the holder or the like fixed to the wall of a room in the portrait orientation, and execute the control according to the landscape orientation when the electronic apparatus 10 is held by the holder or the like in the landscape orientation.

Note that it is also possible to configure, in a case where the orientation of the electronic apparatus 10 is determined not to be the face-down orientation in block B5 of FIG. 10 described above, to detect the bearing in which the electronic apparatus 10 faces as the orientation of the electronic apparatus 10 and execute control according to the bearing as in the above-described second embodiment.

### Fourth Embodiment

Next, the fourth embodiment will be described. Note that the appearance of the electronic apparatus of the present embodiment, the system configuration and the function structure are similar to those of the above-described first embodiment and thus will be appropriately described with reference to FIGS. 1 to 4.

The present embodiment is different from the above-described first embodiment in receiving data associated with the orientation of the electronic apparatus 10 from the contactless communication device 20 and performing control using the received data on the electronic apparatus 10.

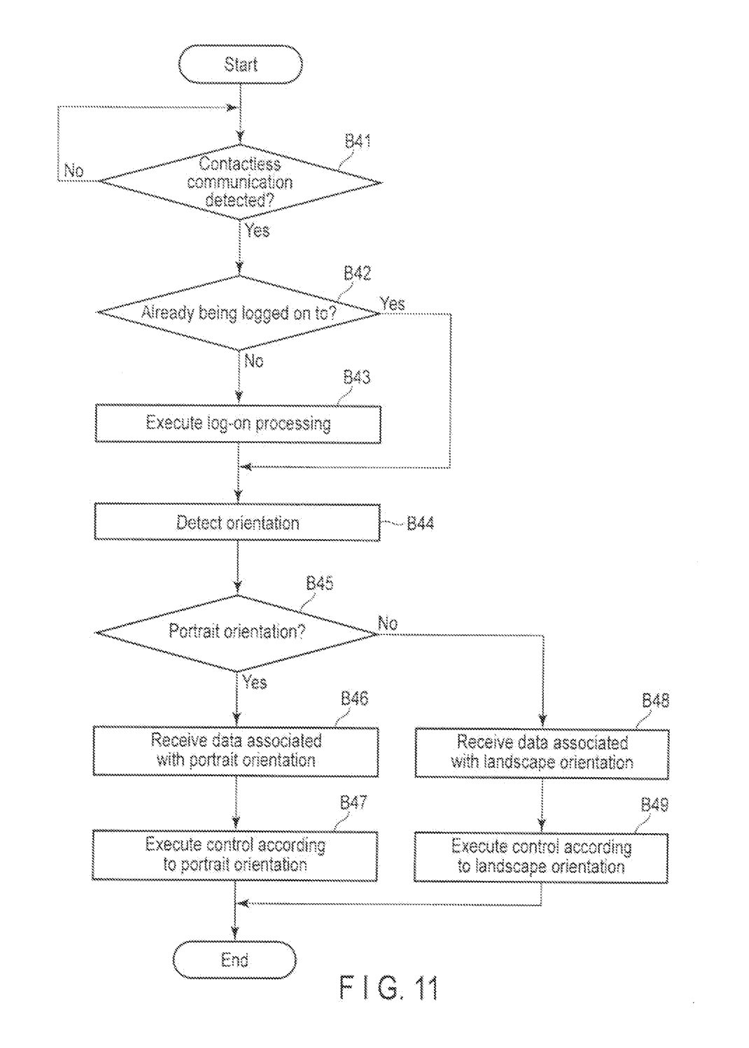

Now, with reference to the flowchart of FIG. 11, the processing procedure in the electronic apparatus 10 of the present embodiment will be described. Here, as in the case of the above-described first embodiment, the processing executed in the electronic apparatus 10 when contactless communication is performed with an external device, namely, the contactless communication device 20 will be described.

First, processing of blocks B41 to B45 corresponding to the above-described processing of blocks B1 to B5 of FIG. 5 is executed.

When it is determined in block B45 that the orientation of the electronic apparatus 10 is the portrait orientation, the controller 114 receives data associated with the portrait orientation (hereinafter referred to as data for the portrait orientation) from the contactless communication device 20 by contactless communication (block B46).

In this case, the controller 114 uses the received data for the portrait orientation and executes control according to the portrait orientation (block B47). Note that this processing of block B47 is executed on the basis of setting data stored in the setting data storage 113.

Conversely, when it is determined on block B45 that the orientation of the electronic apparatus 10 is not the portrait orientation (that is, the landscape orientation), the controller 114 receives data associated with the landscape orientation (hereinafter referred to as data for the landscape orientation) from the contactless communication device 20 by contactless communication (block B48).

In this case, the controller 114 uses the received data for the landscape orientation and executes control according to the landscape orientation (block B49). Note that this processing of block B49 is executed on the basis of setting data stored in the setting data storage 113.

Here, the above-described processing of blocks B46 to B49 will be described more specifically. Here, the setting data storage 113 is assumed to store setting data indicating, as the control according to the portrait orientation on the electronic apparatus 10, activation of, for example, a photo viewing application program (hereinafter referred to as a viewer software) and display of (image data of) a photo in the portrait orientation, and setting data indicating, as the control according to the landscape orientation on the electronic apparatus 10, activation of the viewer software in a manner similar to the above and display of a photo in the landscape orientation. Further, the contactless communication device 20 is assumed to store image date of a portrait photo and a landscape photo.

In this case, image data of a portrait photo is received as the above-described data for the portrait orientation in block B46, and control to display the image data of the portrait photo in the portrait orientation (for example, in a portrait mode) is executed in block B47.

Conversely, image data of a landscape photo is received as the above-described data for the landscape orientation in block B48, and control to display the image data of the landscape photo in the landscape orientation (for example, in a landscape mode) is executed in block B49.

Note that it is assumed in above-described blocks B46 and B48 that the controller 114 notifies the orientation of the electronic apparatus 10 (the portrait orientation or the landscape orientation) (that is, requests data associated with the orientation) to the contactless communication device 20, thereby receiving the data.

Here, it has been assumed that only the data associated with the orientation of the electronic apparatus 10 is received from the contactless communication device 20, but it is also possible to configure the controller 114 to receive all the data stored in the contactless communication device 20 and select data for the orientation of the electronic apparatus 10 from the received data to execute control according to the orientation, for example.

As described above, in the present embodiment, data associated with the orientation of the electronic apparatus 10 detected by the orientation detector 112 is received from the contactless communication device (external device) 20, and control using the received data is performed on the electronic apparatus 10. In the present embodiment, it becomes possible with this configuration, when contactless communication is executed, to control the electronic apparatus 10 to perform an appropriate operation according to the orientation of the electronic apparatus 10 simply by changing the orientation of the electronic apparatus 10.

Further, it is also possible to apply the configuration of the second embodiment to the present embodiment. More specifically, it is possible to configure, when control according to the bearing in which the electronic apparatus 10 faces detected as the orientation of the electronic apparatus 10 is to be executed, to receive data necessary for the execution of the control from the contactless communication device 20.

According to at least one of the embodiments described above, it is possible to provide an electronic apparatus, a method, and a storage medium to perform various operations when contactless communication is performed.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A portable electronic apparatus comprising a contactless communication module configured to execute contactless communication with an external device, comprising:
a first detector configured to detect contactless communication with the external device;
a second detector configured to detect an orientation of the electronic apparatus; and
a controller configured to execute control according to the detected orientation when the contactless communication with the external device is detected.

2. The electronic apparatus of claim 1, comprising an acceleration sensor configured to measure the acceleration due to gravity acting on the electronic apparatus, and wherein
the second detector is configured to detect a portrait orientation or a landscape orientation as the orientation of the electronic apparatus based on the measured acceleration, and
the controller is configured to execute first control according to the portrait orientation when the portrait orientation is detected as the orientation of the electronic apparatus, and executes second control according to the landscape orientation when the landscape orientation is detected as the orientation of the electronic apparatus, the second control being different from the first control.

3. The electronic apparatus of claim 1, comprising a bearing sensor configured to measure a bearing, and wherein
the second detector is configured to detect a bearing in which the electronic apparatus faces as the orientation of the electronic apparatus based on the measured bearing, and
the controller is configured to execute control according to the detected bearing.

4. The electronic apparatus of claim 2, wherein the second detector is configured to detect a face-down orientation as the orientation of the electronic apparatus based on the measured acceleration, and
the controller is configured to execute control to power the electronic apparatus off when the face-down orientation is detected as the orientation of the electronic apparatus.

5. The electronic apparatus of claim 1, wherein the controller is configured to receive data associated with the detected orientation from the external device, and execute control using the received data.

6. The electronic apparatus of claim 1, comprising a log-on processor configured to execute processing to log-on to the electronic apparatus when the contactless communication with the external device is detected.

7. A method of controlling a portable electronic apparatus comprising a contactless communication module configured to execute contactless communication with an external device, comprising:
detecting contactless communication with the external device;
detecting an orientation of the electronic apparatus; and
executing control according to the detected orientation when the contactless communication with the external device is detected.

8. A non-transitory computer-readable storage medium having stored thereon a computer program which is executable by a computer of a portable electronic apparatus comprising a contactless communication module configured to execute contactless communication with an external device, the computer program comprising instructions capable of causing the computer to execute functions of:
detecting contactless communication with the external device;
detecting an orientation of the electronic apparatus; and
executing control according to the detected orientation when the contactless communication with the external device is detected.
